(19) United States
(12) Patent Application Publication
(10) Pub. No.: US 2007/0011735 A1
(43) Pub. Date: Jan. 11, 2007

(54) Open standard conditional access system

(75) Inventors: Joseph W. Weber, San Francisco, CA (US); Edward M. Miller, Broomfield, CO (US); Gregory E. White, Lafayette, CO (US)

Correspondence Address: PATTON BOGGS, 1660 LINCOLN ST, SUITE 2050, DENVER, CO, 80264, US

(73) Assignee: Cable Television Laboratories, Inc., Louisville, CO (US)

(21) Appl. No.: 11/175,530

(22) Filed: Jul. 6, 2005

(51) Int. Cl. G06F 17/00

(52) U.S. Cl. 726/14

(57) ABSTRACT

The present open standard conditional access system uses an open standard protocol for authenticating devices, selectively enabling services, and revoking service on cable and satellite content distribution networks. This system uses a two-way communication protocol between devices in the home and security system servers in the cable network. This allows for security information to be sent only to those devices that need the security information. A two-way communication protocol also allows the end device to request security information instead of waiting for it to be broadcast as in a one-way protocol. The present open standard conditional access system uses the security system already present in most DOCSIS cable modems to protect both IP data and MPEG content.

### FIELD OF THE INVENTION

This invention relates to conditional access systems and the methods used therein for authenticating devices, selectively enabling services, and revoking service on cable and satellite content distribution networks.

### Problem

It is a problem in existing conditional access systems to provide a universal process for authenticating devices, selectively enabling services, and revoking service on cable and satellite content distribution networks. These existing conditional access systems use proprietary methods for authenticating devices, selectively enabling services, and revoking service on cable and satellite content distribution networks. Since these systems are proprietary, they cannot be easily reviewed for the strength of their security.

Existing conditional access systems also broadcast all security information to all devices on the network. They use a one-way communication protocol transmitted from security system servers in the cable network to data decryption devices that are located in the home. These one-way communication protocol systems use Entitlement Management Messages and Entitlement Control Messages (EMM and ECM) that are broadcast to all devices on the network. This potentially creates security problems, since these messages are not transmitted to a single target device and receiving devices cannot be interrogated because there is no return path for communications.

As an example of existing conditional access systems, the OpenCable system uses a removable security device located in the home and the MHP Common Interface specification uses a removable hardware approach to protecting MPEG content. Content is passed from the cable network to a separate removable component located in the home, which component performs the decryption of the scrambled content. However, future cable receivers in the home will have both Data Over Cable Service Interface Specifications (DOCSIS) cable modems for IP data and traditional conditional access systems for MPEG content. This implies the need for two different security systems: Baseline Privacy Interface (BPI) for DOCSIS based Internet Protocol (IP) content and a proprietary system for MPEG content.

Therefore, there is a need for a conditional access system which avoids the need for multiple security systems and also overcomes the above-noted problems associated with proprietary methods for authenticating devices, selectively enabling services, and revoking service on cable and satellite content distribution networks.

### Solution

The above-described problems are solved and a technical advance achieved by the present open standard conditional access system which uses an open standard protocol for authenticating devices, selectively enabling services, and revoking service on cable and satellite content distribution networks.

The present open standard conditional access system uses a two-way communication protocol between devices in the home and security system servers in the cable network. This allows for security information to be sent only to those devices that need the security information and for devices to communicate back to the security system in the cable network. A two-way communication protocol also allows the end device to request security information instead of waiting for it to be broadcast as in a one-way protocol, and to verify receipt of security information. This is important for authentication of individual devices. The present open standard conditional access system also enables anyone to assess the strength of the security model in use on a cable or satellite content distribution network.

The present open standard conditional access system uses the security system already present in most DOCSIS cable modems and therefore does not require a separate removable module or proprietary methods for authenticating devices, selectively enabling services, and revoking service on cable and satellite content distribution networks. Data Over Cable Service Interface Specifications (DOCSIS) define the Baseline Privacy Interface (BPI) for protecting Internet Protocol (IP) content. The present open standard conditional access system extends the use of Baseline Privacy Interface to protect other digital content (termed non-IP data) over the interfaces besides DOCSIS, including but not limited to MPEG content.

Therefore, the present open standard conditional access system uses a common security protocol, Baseline Privacy Interface, for both types of data: IP data and MPEG content. This eliminates the need to broadcast Entitlement Control Messages and Entitlement Management Messages for authentication, provisioning, and key exchange as well as conditional access of video services.

### BRIEF DESCRIPTION OF THE DRAWINGS

FIG. 1 illustrates in block diagram form the functional components of the present open standard conditional access system; and

FIGS. 2A-2C illustrate in flow diagram form the operation of the present open standard conditional access system.

### DETAILED DESCRIPTION OF THE DRAWINGS

System Environment

A Cable Modem Termination System (CMTS) is a system of devices that allows cable television operators to offer high-speed Internet access to home computers. The Cable Modem Termination System sends and receives digital cable modem signals on a cable network, receiving signals sent upstream from a subscriber's cable modem, converting the signals to IP packets, and routing the packets on to an Internet Service Provider (ISP) for connection to the Internet. The Cable Modem Termination System also sends signals downstream from the Internet to the user's cable modem. Cable modems cannot communicate directly with each other; they must communicate by channeling their signals through the Cable Modem Termination System.

DOCSIS (Data Over Cable Service Interface Specification) is a standard interface for cable modems, the devices that handle incoming and outgoing data signals between the cable operator and a subscriber's personal or business computer or television set. DOCSIS specifies modulation schemes and the protocol for exchanging the bidirectional signals over cable. In other words, DOCSIS is the protocol used for sending and receiving signals between the subscriber cable modem and the CMTS where the signals are converted to/from DOCSIS from/to IP packets.

In a DOCSIS-based cable data system, the Media Access Control (MAC) address of the subscriber's modem is the modem's unique hardware number assigned to the cable modem by the manufacturer of the cable modem. When the subscriber is connected to the Internet, a corresponding table is used to correlate the subscriber's IP address to the cable modem's MAC address. The MAC address is used for routing data over the cable network while the IP address is used for routing data over the Internet.

Open Standard Conditional Access System

The present open standard conditional access system uses the existing Baseline Privacy Interface security system of DOCSIS for authentication, provisioning, and key exchange, while the encrypted content is delivered in the standard MPEG-2 transport over QAM channels (rather than over IP). Content, in MPEG-2 compression format or other digital formats, may also be sent over IP and is protected by this method. All Out Of Band (OOB) communications use DOCSIS and are secured by Baseline Privacy Interface. The conditional access information therefore remains in the network, increasing the level of security and simplifying the consumer device, since it does not need to know any details of the conditional access system's entitlements and key management algorithms. The Cable Modem 5 within the Customer Premise Equipment 4 must support all ciphers as well as multiple concurrent Dynamic Security Associations. Presently, DOCSIS modems support only one or more Dynamic Security Associations.

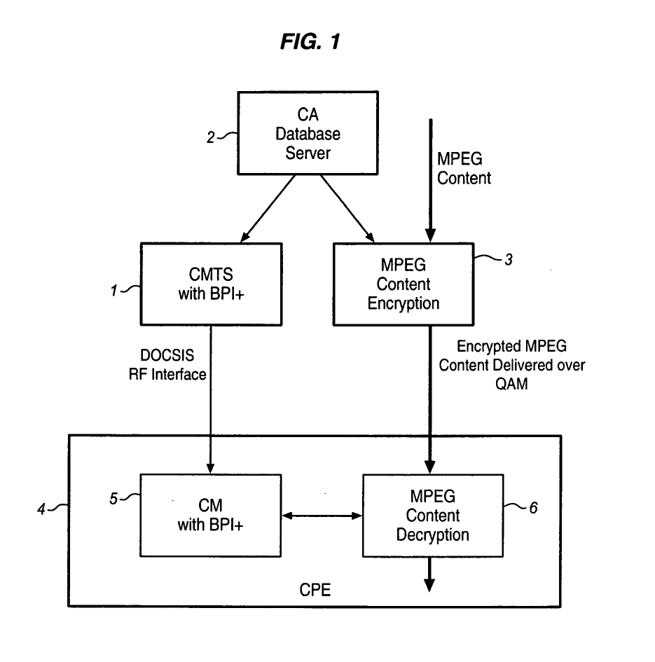

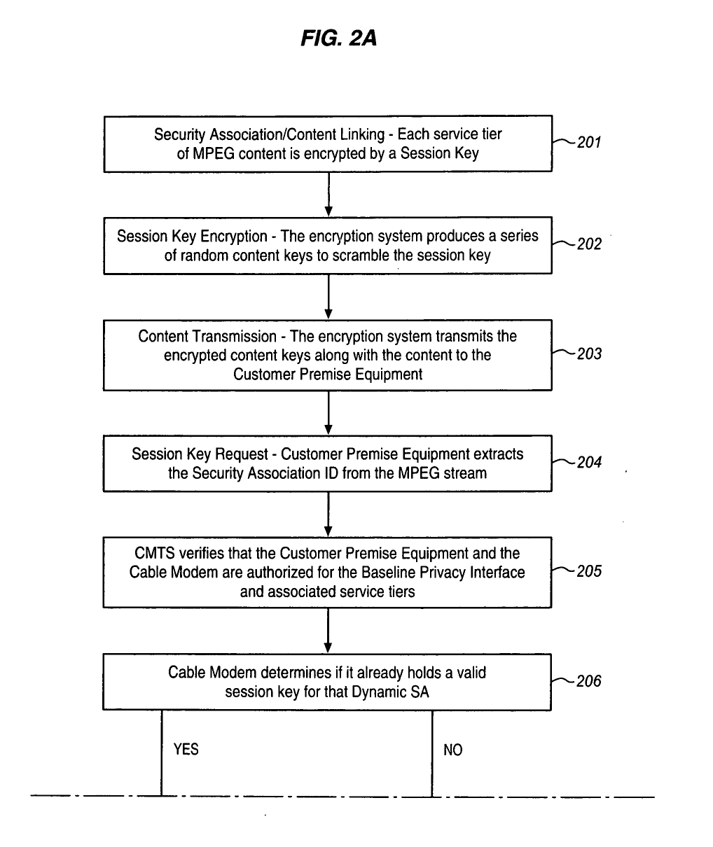

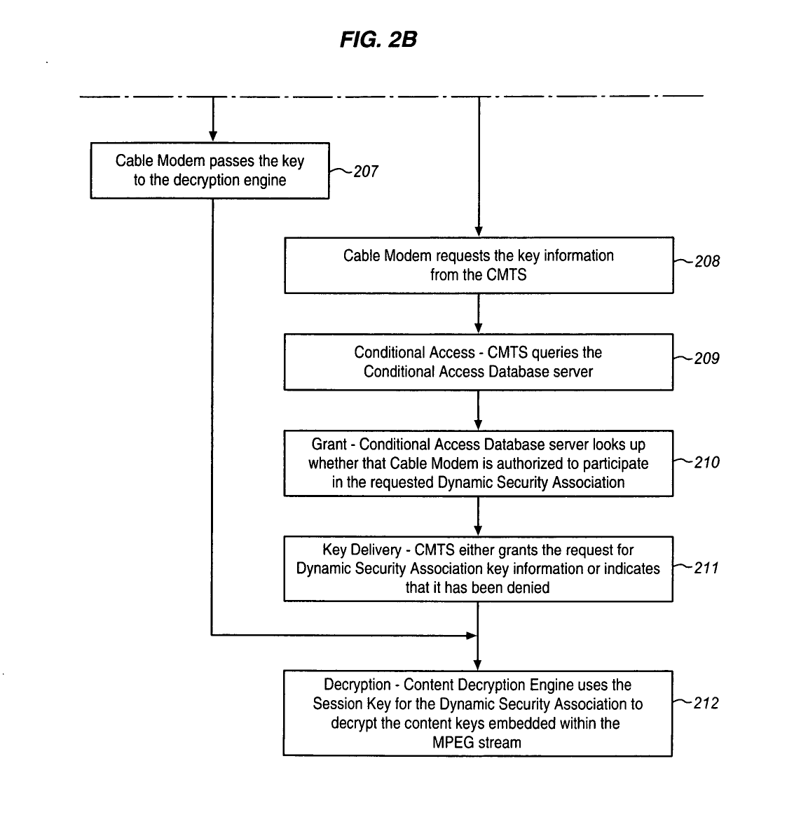

FIG. 1 illustrates in block diagram form the functional components of the present open standard conditional access system; and FIGS. 2A-2C illustrate in flow diagram form the operation of the present open standard conditional access system. The present open standard conditional access system makes use of a Baseline Privacy Interface of a Cable Modem Termination System for provisioning, authentication, and revocation, as well as conditional access of video services. Video content is delivered via a traditional MPEG-2 TS over QAM and not over DOCSIS. The conventional use of Baseline Privacy Interface is for encrypting flows over DOCSIS. In this model, the Baseline Privacy Interface keys are used to encrypt the payloads of MPEG-2 transport streams delivered over QAM. The Head End System 1 consists of a Cable Modem Termination System 1 with an interface to the Baseline Privacy Interface Security system. MPEG content is encrypted by an MPEG Content Encryption Device 3 that receives the Baseline Privacy Interface security keys from the Conditional Access Database Server 2. The Conditional Access Database Server 2 keeps track of customer records, including service entitlements, Customer Premise Equipment IDs, and the associations between MPEG content encryption keys and various service tiers. Within the customer premises, each Customer Premise Equipment 4 that is authorized to view content contains a Cable Modem 5 with Baseline Privacy Interface hardware and the associated Content Decryption Engine 6 necessary for decrypting the MPEG content received from a QAM channel. The Cable Modem 5 delivers the encryption keys to the Content Decryption Engine 6.

The present open standard conditional access system replaces the in-band Entitlement Control Messages of traditional conditional access systems with Security Association information and content keys from the Baseline Privacy Interface interface. Entitlement Management Messages are replaced with Baseline Privacy Interface key management. Therefore, the system takes advantage of the two-way capabilities of the cable plant to eliminate the need for Entitlement Control Messages and Entitlement Management Messages.

Conditional Access Process

FIGS. 2A-2C illustrate in flow diagram form the operation of the present open standard conditional access system. In this process, the Conditional Access Database Server 2 generates a Session Key to encrypt each service tier of MPEG content at step 201. A service tier could consist of many MPEG programs, such as an “extended basic” tier, or a single program such as “HBO.” The Conditional Access Database Server 2 maintains a list of all MPEG programs and their associated service tiers as well as the session keys. Each Session Key has a corresponding Dynamic Security Association (Dynamic SA) within the Baseline Privacy Interface system of the Cable Modem Termination System 1. Security Associations are identified by a 14-bit Security Association ID (Security Association ID).

At step 202, the MPEG Content Encryption System 3 produces a series of random content keys. These keys are used to scramble the MPEG content using the standard MPEG encryption methods: MPEG packet headers remain unencrypted while the data payloads are encrypted. How the content keys are generated, and how often they are updated, are left up to the security method used and need not be specified. The cable operator can choose their own level of sophistication to meet their security demands. Once the random content keys are generated, the MPEG Content Encryption System 3 encrypts the content keys with the session key for that service flow at step 203. The encrypted content keys are then transmitted by the MPEG Content Encryption System 3 in-band along with the content to the Customer Premise Equipment 4 at 204. The MPEG system standard provides places for inserting those encrypted content keys along with the content. The use of Entitlement Management Messages and Entitlement Control Messages in-band is not required. The Security Association ID associated with that service tier is also transmitted along with the scrambled content keys. When the Customer Premise Equipment 4 receives encrypted content, it extracts the Security Association ID from the MPEG stream at step 205. The Security Association ID is then passed to the Cable Modem 5. Encrypted content is identified by the encryption bit of the MPEG transport header.

The Baseline Privacy Interface initialization process includes an authentication procedure of Cable Modem 5. Using the Cable Modem's unique MAC address and X.509 certificates, the Cable Modem Termination System 1 can verify that the Customer Premise Equipment and the Cable Modem are authorized for the Baseline Privacy Interface and associated service tiers at step 206. Because each MAC address is unique, the Baseline Privacy Interface system can be conveniently used for provisioning and removing service tiers for individual Customer Premise Equipment 4 associated with customers. The Conditional Access Database Server 2 maintains a list of associations of MAC addresses and customer IDs. The customer IDs can then be used to find which service tiers the customer has been authorized for. Given the Security Association ID, the Cable Modem 5 determines if it already holds a valid session key in a session key memory for that Dynamic Security Association at step 207. If so, Cable Modem 5 passes the key to the Content Decryption Engine 6 at step 208 and processing advances to step 213 as described below. If not, Cable Modem 5 requests the key information from the Cable Modem Termination System 1 at step 209.

When the Cable Modem Termination System 1 receives a request for Dynamic Security Association key information, it queries the Conditional Access Database Server 2 at step 210 to see if that Cable Modem 5 is authorized to receive the content tier associated with the Security Association ID. The Conditional Access Database Server 2 contains information linking each unique Cable Modem MAC address to a customer ID and, therefore, to a list of services authorized for that Customer Premise Equipment 4 for that customer. Conditional Access Database Server 2 at step 211 looks up whether that Cable Modem 5 is authorized to participate in the requested Dynamic Security Association. The Cable Modem Termination System 1 at step 212 either grants the request for Dynamic Security Association key information or indicates that it has been denied. If granted, the key information is sent to the Cable Modem 5, encrypted by that Cable Modem's unique Primary Security Association. The Content Decryption Engine 6 uses the Session Key for the Dynamic Security Association associated with the Security Association ID to decrypt the content keys embedded within the MPEG stream at step 213. The content keys are then used to extract the content by decrypting the payloads of the MPEG-3 transport stream packets and the content is then available to the Customer Premise Equipment 4.

What is claimed:

1. A system for implementing a communication protocol between devices in a home and security system servers in a cable network for delivering both IP data and non-IP data content, comprising:
means for maintaining a communication protocol between devices in a home and security system servers in a cable network for the exchange of IP data; and
means, using said communication protocol, for creating a communication session between said devices in a home and said security system servers in a cable network for exchanging non-IP data content.

2. The system for implementing a communication protocol of claim 1 wherein said means for creating a communication session comprises:
conditional access database means for generating at least one random content key for encrypting said non-IP data content; and
content key encryption means for encrypting said at least one random content key with a session key.

3. The system for implementing a communication protocol of claim 2 further comprising:
transmitting means for transmitting said encrypted non-IP data content and said encrypted random content key to said device.

4. The system for implementing a communication protocol of claim 3 further comprising:
key storage means, located in said device, for determining whether said session key received from said transmitting means is presently stored in said device; and
content extraction means, responsive to a presence of said session key, for decrypting said non-IP data content.

5. The system for implementing a communication protocol of claim 3 wherein said means for creating a communication session further comprises:
device authorization means, responsive to receipt of a request from said device indicative of an absence of said session key received from said transmitting means in said device, for determining whether said device is authorized to receive said encrypted non-IP data content; and
key delivery means, responsive to a determination that said device is authorized to receive said encrypted non-IP data content, for transmitting said session key to said requesting device.

6. The system for implementing a communication protocol of claim 5 further comprising:
content extraction means, responsive to receipt of said session key, for decrypting said non-IP data content.

7. The system for implementing a communication protocol of claim 1 wherein said means for creating a communication session comprises:
a two-way communication protocol between said device and said security system servers in said cable network.

8. A method for implementing a communication protocol between devices in a home and security system servers in a cable network for delivering both IP data and non-IP data content, comprising:
maintaining a communication protocol between devices in a home and security system servers in a cable network for the exchange of IP data; and
creating, using said communication protocol, a communication session between said devices in a home and said security system servers in a cable network for exchanging non-IP data content.

9. The method for implementing a communication protocol of claim 8 wherein said step of creating a communication session comprises:
generating at least one random content key for encrypting said non-IP data content; and
encrypting said at least one random content key with a session key.

10. The method for implementing a communication protocol of claim 9 further comprising:
transmitting said encrypted non-IP data content and said encrypted random content key to said device.

11. The method for implementing a communication protocol of claim 10 further comprising:
determining in said device, whether said session key received from said security system servers in said cable network is presently stored in said device; and
decrypting, in response to a presence of said session key, said non-IP data content.

12. The method for implementing a communication protocol of claim 10 wherein said step of creating a communication session further comprises:
determining, in response to receipt of a request from said device indicative of an absence of said session key, received from said security system servers in said cable network, whether said device is authorized to receive said encrypted non-IP data content; and
transmitting, in response to a determination that said device is authorized to receive said encrypted non-IP data content, said session key to said requesting device.

13. The method for implementing a communication protocol of claim 5 further comprising:
decrypting, in response to receipt of said session key, said non-IP data content.

14. The method for implementing a communication protocol of claim 1 wherein said step of creating a communication session comprises:
implementing a two-way communication protocol between said device and said security system servers in said cable network.
